(19) United States
(12) Patent Application Publication
(10) Pub. No.: US 2025/0347928 A1
(43) Pub. Date: Nov. 13, 2025

(54) GLASSES WITH INTERCHANGEABLE LENSES

(71) Applicant: ARGUS VISION INTERNATIONAL LIMITED, Tainan (TW)

(72) Inventor: Lin -Yun Chen, Tainan (TW)

(21) Appl. No.: 19/203,189

(22) Filed: May 9, 2025

(30) Foreign Application Priority Data
May 13, 2024 (TW) 113117596

(51) Int. Cl. G02C 5/22; G02C 3/00; G02C 5/14; G02C 11/08

(52) U.S. Cl. CPC G02C 5/2209; G02C 3/003; G02C 5/14; G02C 11/08; G02C 2200/04; G02C 2200/08; G02C 2200/14

(57) ABSTRACT

Provided is a pair of glasses with interchangeable lenses, including a lens, two pivot fasteners and a wearing piece. A mounting base is provided on both sides of the lens. A mounting base is provided with a stopper at the front section and a mounting hole at the rear section. A limiting portion is provided at the front section of each pivot fastener, and a mounting shaft extending downward is provided. Each pivot fastener is detachably inserted into the mounting hole by the mounting shaft. Each pivot fastener is pivoted relative to the mounting base between an unfolded position and a folded position by the mounting shaft as the axis, and the wearing piece is connected to the rear section of each pivot fastener. When each pivot fastener is pivoted to the unfolded position, the limiting portion is pivoted and forced into the inner surface of the stopper to be fixed. When each pivot fastener is pivoted to the folded position, the limiting portion is pivoted out of the stopper, and each pivot fastener is operable to disengage the mounting shaft from the mounting hole, such that each pivot fastener can be detached from the mounting base.

### BACKGROUND OF THE INVENTION

### 1. Field of the Invention

The present disclosure relates to a pair of glasses, and particularly relates to a structure in which the lenses can be separated or combined in the temples without the aid of a tool, and the lenses can be replaced.

### 2. The Prior Arts

Glasses usually have a single function, including correction of myopia, hyperopia, astigmatism, presbyopia or strabismus, etc. There are other functional glasses such as goggles, sunglasses, sports glasses, etc., which provide various protections for the eyes and allow consumers to choose to wear them for different occasions. Accordingly, nowadays, consumers usually own multiple pairs of glasses with different functions for replacement. However, the above situation also causes financial burden to the consumers and also causes the problem of storing glasses.

Afterwards, glasses with replaceable lenses were born. The main structure thereof is arranged on the periphery of the lens and the periphery of the frame, which allows consumers to disassemble and replace the lenses by themselves, and then re-engage them onto the frames. This structure is commonly found in half-rimmed glasses or full-rimmed glasses. However, most of the existing frameless glasses have temples directly connected to both sides of the lens, and there are few replacement lens structures designed for frameless glasses. As such, the traditional glasses structure has gradually failed to meet the needs of users for innovation, change, or even diversified.

### SUMMARY OF THE INVENTION

In view of the shortcomings and deficiencies of the prior art, the main objective of the present disclosure is to improve the problems of energy consumption and time consumption caused by the existing structure.

In order to achieve the above-mentioned objective, the technical means adopted in the present disclosure is a pair of glasses with interchangeable lenses. A side facing a wearer's face is defined as an inner surface and a side not facing the wearer's face is defined as an outer surface. The glasses comprises: a lens, two pivot fasteners and a wearing piece.

The lens is provided with a mounting base on both sides thereof. A front section of the mounting base is provided with a stopper, and a rear section of the mounting base is provided with a mounting hole.

A front section of each of the pivot fasteners is provided with a limiting portion, a downwardly extending mounting shaft is provided spaced apart from the limiting portion. Each of the pivot fasteners is separably inserted in the mounting hole with the mounting shaft, and each of the pivot fasteners pivots with the mounting shaft against the mounting base between an unfolded position and a folded position.

The wearing piece coupled to a rear section of each of the pivot fasteners.

When each of the pivot fasteners is pivoted from the folded position to the unfolded position, the limiting portion is pressed into the inner surface of the stopper to be fixed along with pivoting; and when each of the pivot fasteners is pivoted from the unfolded position to the folded position, the limiting portion is forced out of the stopper along with the pivoting, each of the pivot fasteners is operable to disengage the mounting shaft from the mounting hole, and each of the pivot fasteners is detached from the mounting base, thereby improving the convenience of replacing the lens.

### BRIEF DESCRIPTION OF THE DRAWINGS

FIG. 1 is a three-dimensional schematic diagram showing the present disclosure.

FIG. 2 is a schematic diagram showing the partial decomposition according to the present disclosure.

FIG. 3 is a schematic diagram showing the assembly according to the present disclosure.

FIG. 4 is a schematic cross-sectional diagram showing the closing and opening of the pivot fastener according to the present disclosure.

FIG. 5 is a schematic diagram showing the process of opening the pivot fastener according to the present disclosure.

FIG. 6 is a schematic diagram showing the three-dimensional assembly of FIG. 2.

FIG. 7 is a three-dimensional schematic diagram showing an embodiment according to the present disclosure.

FIGS. 8 and 9 are schematic diagrams showing the decomposition of FIG. 8.

FIG. 10 is a schematic diagram showing the three-dimensional combination of FIG. 9.

FIG. 11 is a schematic diagram showing a cross-section of FIG. 8 along the line A-A.

FIGS. 12 and 13 are schematic cross-sectional diagrams showing embodiments according to the present disclosure.

### DETAILED DESCRIPTION OF THE PREFERRED EMBODIMENT

The following is a specific embodiment to illustrate the implementation of the present disclosure. Persons skilled in the art can easily understand the other advantages and effects of the present disclosure from the disclosure in the specification.

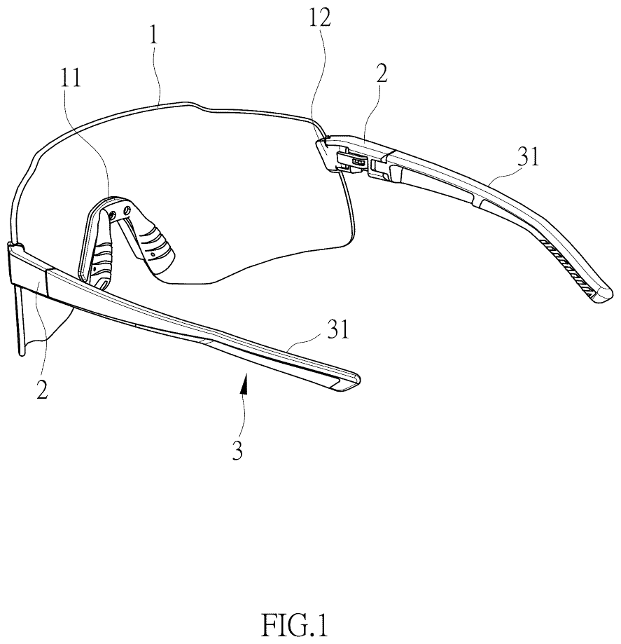

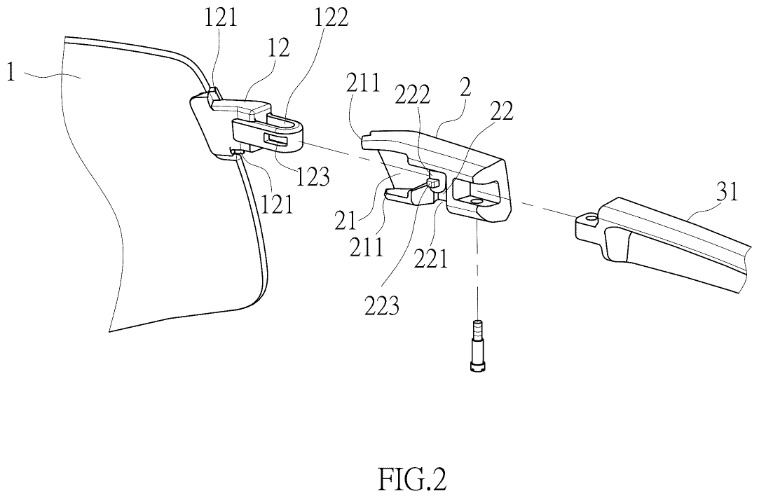

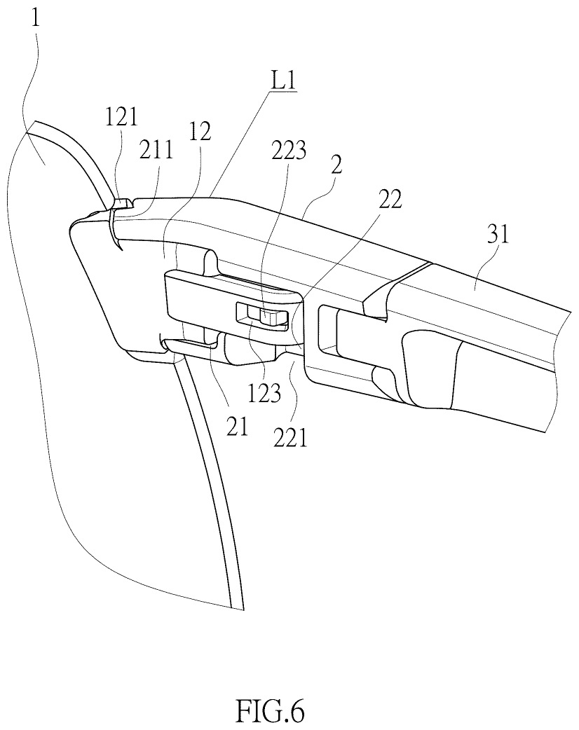

Referring to FIG. 1 to FIG. 6, according to a preferred embodiment of the present disclosure, a lens-changeable glasses is provided. The side facing a wearer's face is defined as the inner surface, and the side not facing the wearer's face is defined as the outer surface, and the glasses mainly includes a lens 1, a pivot fastener 2, and a wearing piece 3.

A nose bridge cover 11 is provided at the lower edge of the center of lens 1, and a mounting base 12 is provided on both sides thereof. The front section of the mounting base 12 is combined with the lens 1. The present disclosure does not limit the manner in which the mounting base 12 is combined with the lens 1, and it is secured to the lens 1 on both sides of the lens 1 by one of gluing, welding, locking, embedding, or secondary injection. A stopper 121 extends from the top and bottom of the front section of the mounting base 12, and a longitudinally penetrating mounting hole 122 is provided at the rear section of the mounting base 12. In the embodiment of the present disclosure, the mounting hole 122 is in the shape of an elongated hole, but is not limited thereto. In addition, in the embodiment of the present disclosure, the lens 1 is a one-piece type, but is not limited thereto. It can also be a two-piece type, and the lens can be one of a prescription lens, a sunshade lens, a goggle lens, or a photochromic lens.

The inner surface of each pivot fastener 2 is provided with a clamping slot 21 and a pivot slot 22, and a limiting portion 211 is extended from the top to bottom of the front section of each clamping slot 21. The pivot slot 22 has a lower opening 221. The shapes of the clamping slot 21 and the pivot slot 22 match the shape of the mounting base 12. A mounting shaft 222 extends downward from the top of the pivot slot 22, and each pivot fastener 2 can be detachably inserted in the mounting hole 122 by the mounting shaft 222. Each pivot fastener 2 is pivoted relative to the mounting base 12 between an unfolded position L1 and a folded position L2 with the mounting shaft 222 as the axis.

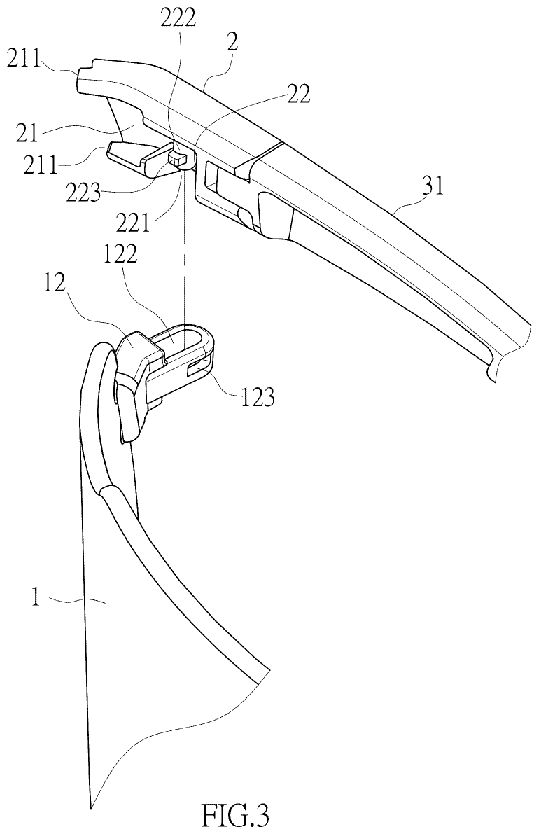

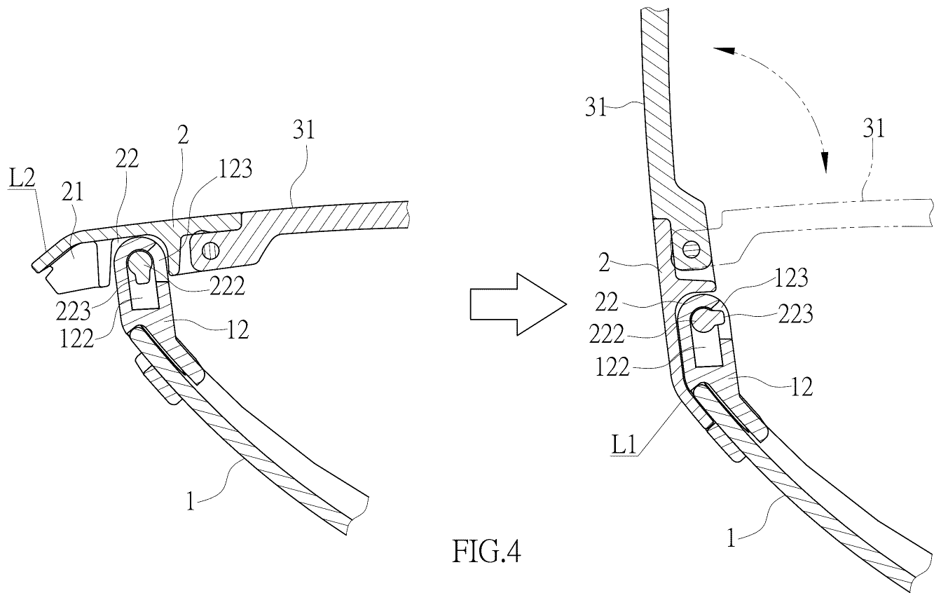

The wearing piece 3 may be a belt or two temples 31. The present disclosure takes two temples 31 as an example for illustration. As shown in FIG. 4, each of the temples 31 is respectively pivotally connected to the rear section of each of the pivot fasteners 2 and can be pivoted relative to the pivot fasteners 2. The present disclosure does not limit the sequence of assembling each of the temples 31. As shown in FIG. 3, each of the temples 31 may be first1 pivotally connected to each of the pivot fasteners 2 first, and then each of the pivot fasteners 2 is assembled on the mounting base 12. Alternatively, each of the pivot fasteners 2 is assembled on the mounting base 12, and then each of the temples 31 is pivotally connected to the rear section of each of the pivot fasteners 2.

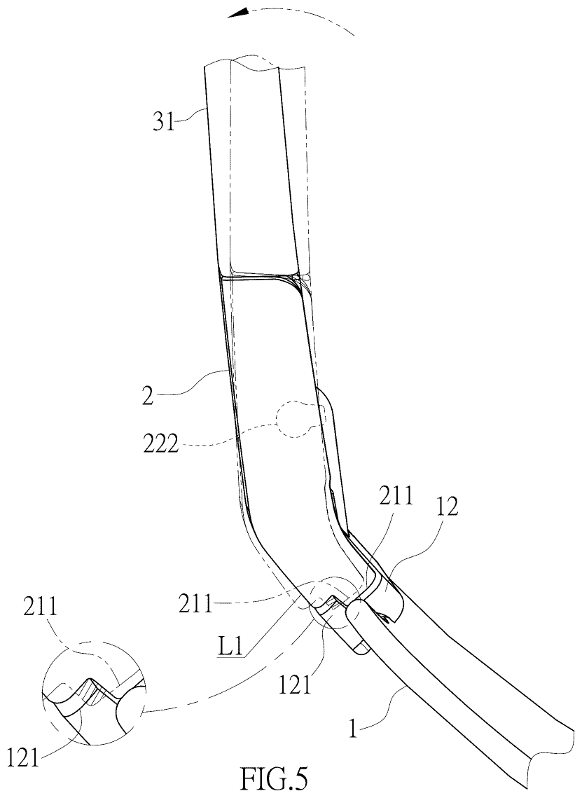

Referring to FIG. 3 to FIG. 6, when each of the pivot fasteners 2 is actually assembled, each of the pivot fasteners 2 is first placed in the folded position L2, the mounting shaft 222 is inserted into the mounting hole 122 from the top to the bottom, and subsequently each of the pivot fasteners 2 is pivoted from the folded position L2 to the unfolded position L1. As shown in FIG. 5, the limit portion 211 pivots to the stopper 121 to form an interference. The partially enlarged view is to indicate the part of the pivot interference by the slash area. The user only needs to apply a slight force during the pivoting to force the limit part 211 into the inner surface of the stopper 121 to form a fixation. In addition, when each of the pivot fasteners 2 is in the unfolded position L1, and the mounting base 12 is partially accommodated in the clamping slot 21 and the pivot slot 22, thereby limiting the longitudinal displacement of each of the pivot fasteners 2 relative to the mounting base 12.

When the user replaces the lens 1, the user only needs to apply force to press the outer surface of the rear section of each pivot fastener 2, such that the pivot fastener 2 pivots from the unfolded position L1 to the folded position L2 with the mounting shaft 222 as the axis. The limit part 211 is pivoted to force out the stopper 121, and each of the pivot fasteners 2 can be operated to disengage the mounting shaft 222 from the mounting hole 122, such that each of the pivot fasteners 2 together with the temples 31 are detached from the mounting base 122 for replacement of the lens 1. Alternatively, as shown in FIG. 3, the pivot fasteners 2 together with the temples 31 are replaced.

In order to make the assembly structure of each pivot fastener 2 more reliable, a protrusion 223 is provided on the outer edge of the mounting shaft 222 of each pivot fastener 2. The inner surface of the mounting base 12 is provided with an embedding groove 123 connected to the mounting hole 122. When each of the pivot fasteners 2 is pivoted to the unfolded position L1, the protrusion 223 is embedded in the embedding groove 123 along with the pivoting, thereby further limiting the longitudinal displacement of each of the pivot fasteners 2 relative to the mounting base 12. When each of the pivot fasteners 2 is pivoted to the folded position L2, as shown in FIG. 4, the protrusion 223 will be disengaged from the embedding groove 123 as the pivot fasteners 2 are pivoted, so as to facilitate detachment of the pivot fasteners 2 for replacement of the lens 1.

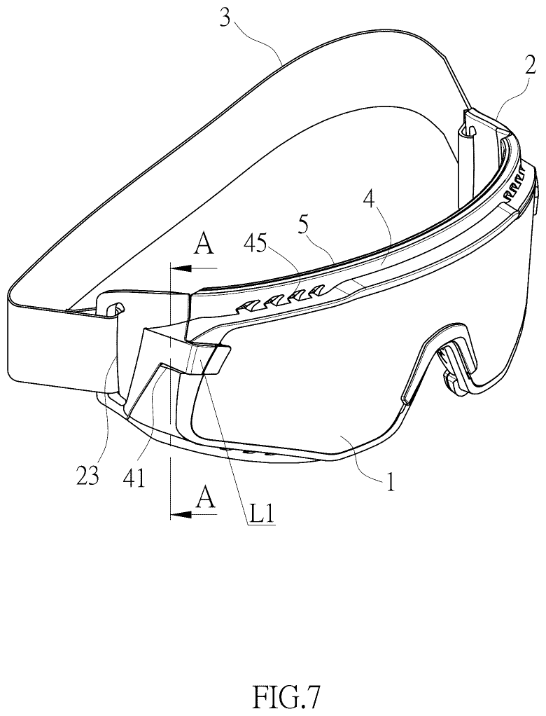

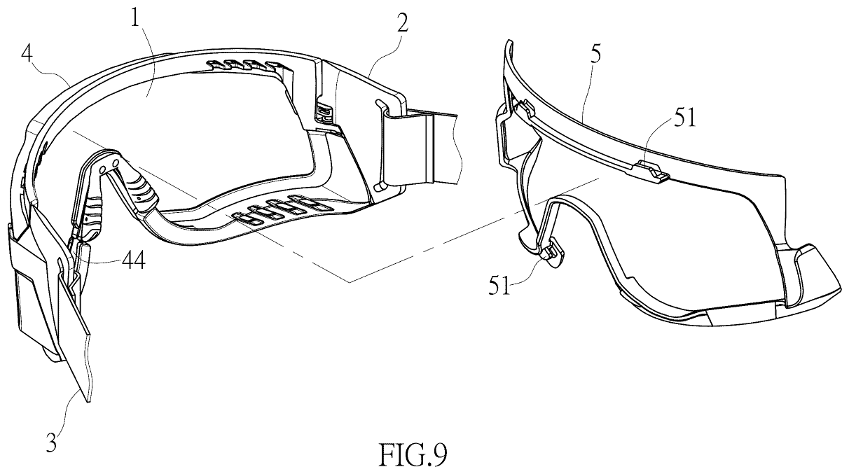

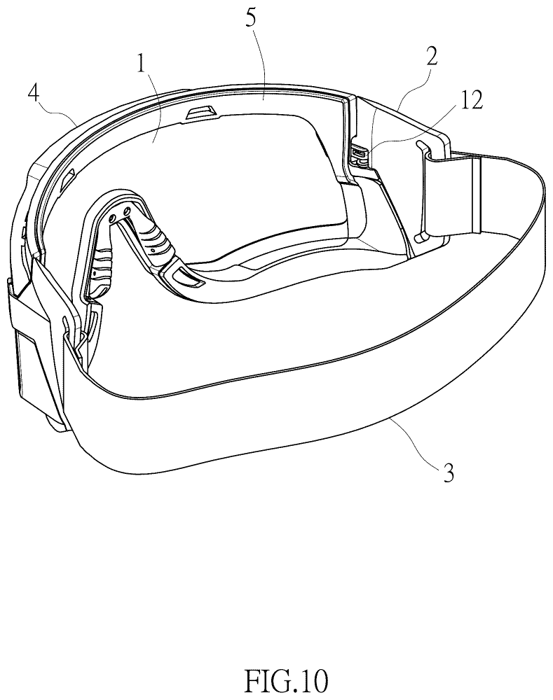

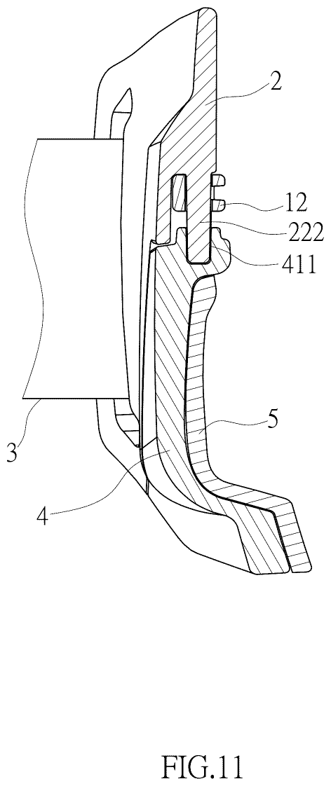

Referring to FIG. 7 to FIG. 12, which show embodiments of the present disclosure in accordance with the structural variations described above, and the same structures will not be repeated. In the embodiment of the present disclosure, the rear end of each of the pivot fasteners 2 is provided with a strap hole 23, and the wearing piece 3 is a belt body. The two ends of the wearing piece 3 are respectively coupled to the strap holes 23. The belt body may be an elastic band or a hook and loop fastener, but is not limited thereto. Any belt body that can be combined in the rear end of each of the pivot fasteners 2 and can be worn and fixed to the user's head is within the scope of the present disclosure.

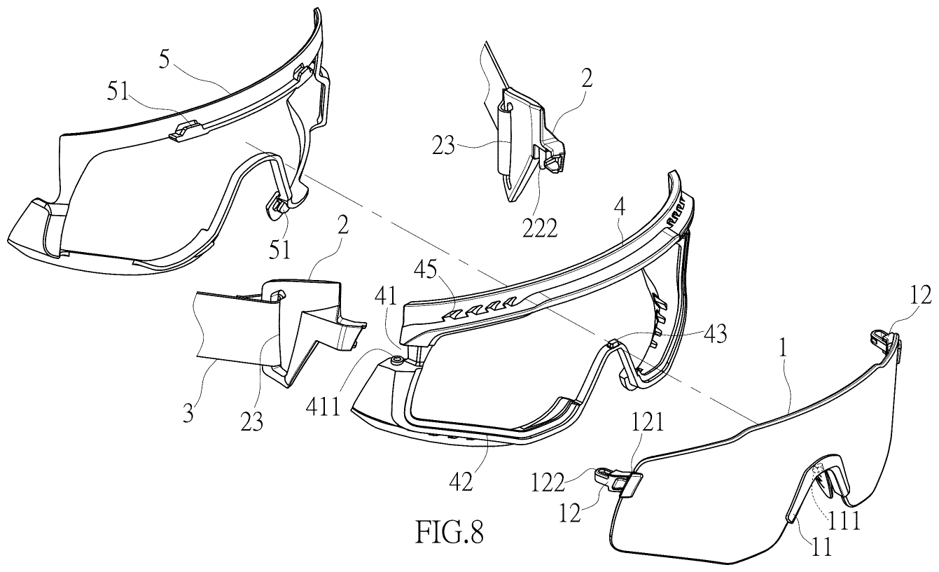

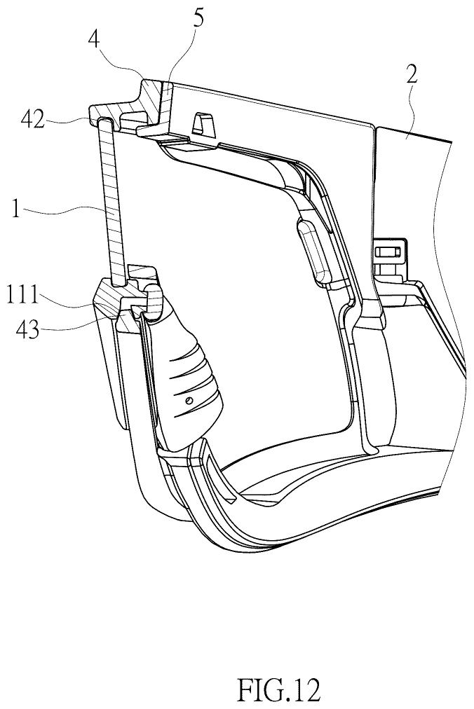

The present disclosure further includes a front frame 4. The front frame 4 is provided with a groove 41 on both sides thereof, and a socket 411 is provided at the bottom of each groove 41. The insertion hole 411 is coaxial with the mounting shaft 222. As shown in FIG. 8 and FIG. 12, the front frame 4 is further provided with a lens groove 42 and a positioning protrusion 43. The front frame 4 is provided with a plurality of ventilation holes 45 around the periphery of the lens groove 42. In the embodiment of the present disclosure, the lens groove 42 is arranged on the outer surface of the front frame 4, and the positioning protrusion 43 is located at the inner frame edge of the front frame 4 corresponding to the bridge of the human nose of the human body. The nose bridge cover 11 of the lens 1 is recessed with a positioning groove 111, the lens 1 is detachably arranged in the lens groove 42, and the positioning protrusion 43 is embedded in the positioning groove 111 to form a positioning.

As shown in FIG. 7 to FIG. 11, after each of the pivot fasteners 2 is assembled on each of the mounting bases 12, the end of each of the mounting shafts 222 is inserted into each of the insertion holes 411. In addition, when each of the pivot fasteners 2 is in the unfolded position L1, a portion thereof is accommodated in each of the grooves 41, thereby limiting the longitudinal displacement of each of the pivot fasteners 2 relative to each of the mount bases 12.

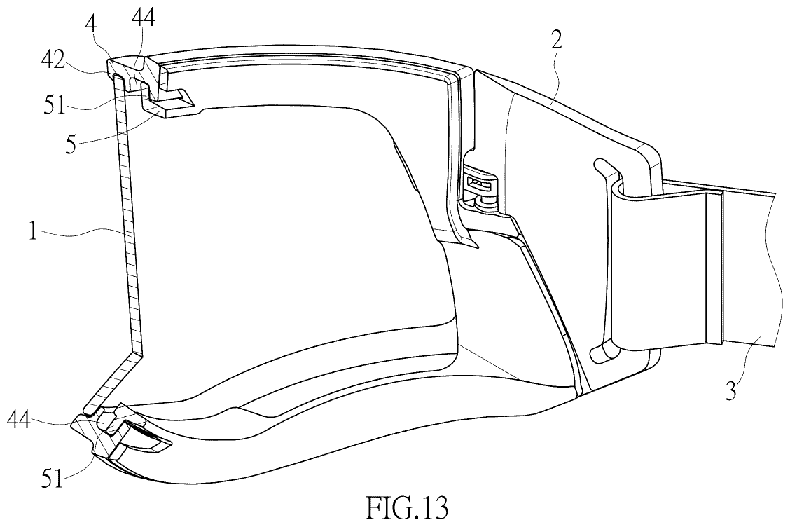

Furthermore, the embodiment of the present disclosure further includes a rear frame 5 detachably arranged on the inner surface of the front frame 4, and the frame edge of the rear frame 5 is provided with a plurality of hook portions 51. The frame edge of the inner surface of the front frame 4 is provided with a plurality of outwardly facing trenches 44, as shown in FIG. 13, and the rear frame 5 is secured by hooking each of the hook portions 51 correspondingly in the trenches. The present disclosure does not limit the material of the rear frame 5, which may be made of plastic or flexible and cushioning material, such as rubber, silicone, foam, and the like.

Herein, the embodiment of the present disclosure forms the form of sports glasses by configuring the front frame 4 and the rear frame 5 and replacing the wearing piece 3. In addition to being able to quickly replace the lens 1 without the aid of tools, the present disclosure can also be used with different types of wearing piece 3 to enhance product diversity and market competitiveness.

Although the present disclosure has been described with reference to the preferred exemplary preferred embodiments thereof, it is apparent to those skilled in the art that a variety of modifications and changes may be made without departing from the scope of the present disclosure which is intended to be defined by the appended claims.

What is claimed is:

1. A pair of glasses having interchangeable lenses, wherein a side facing a wearer's face is defined as an inner surface and a side not facing the wearer's face is defined as an outer surface, and the glasses comprising:
a lens provided with a mounting base on both sides thereof, wherein a front section of the mounting base is provided with a stopper, and a rear section of the mounting base is provided with a mounting hole;
two pivot fasteners, wherein a front section of each of the pivot fasteners is provided with a limiting portion, a downwardly extending mounting shaft is provided spaced apart from the limiting portion, each of the pivot fasteners is separably inserted in the mounting hole with the mounting shaft, and each of the pivot fasteners pivots with the mounting shaft against the mounting base between an unfolded position and a folded position; and
a wearing piece coupled to a rear section of each of the pivot fasteners,
wherein when each of the pivot fasteners is pivoted from the folded position to the unfolded position, the limiting portion is pressed into the inner surface of the stopper to be fixed along with pivoting; and when each of the pivot fasteners is pivoted from the unfolded position to the folded position, the limiting portion is forced out of the stopper along with the pivoting, each of the pivot fasteners is operable to disengage the mounting shaft from the mounting hole, and each of the pivot fasteners is detached from the mounting base.

2. The pair of glasses having interchangeable lenses of claim 1, wherein the mounting shaft of each of the pivot fasteners is provided with a protrusion, the inner surface of the mounting base is provided with an embedding groove connected to the mounting hole; when each of the pivot fasteners is pivoted to the unfolded position, the protrusion is inserted into the embedding groove along with the pivoting, and when each of the pivot fasteners is pivoted to the folded position, the protrusion is separated from the embedding groove along with the pivoting.

3. The pair of glasses having interchangeable lenses of claim 1, wherein the inner surface of each of the pivot fasteners is provided with a clamping slot and a pivot slot connected to the clamping slot, the pivot slot has a lower opening, the mounting shaft extends downwardly from the top of the pivot slot, and when each of the pivot fasteners is in the unfolded position, the mounting base is partially accommodated in the clamping slot and the pivot slot.

4. The pair of glasses having interchangeable lenses of claim 1, further comprising a front frame, wherein a groove is respectively provided on both sides of the front frame, a bottom of each groove is provided with an insertion hole coaxial with the mounting shaft, the front frame is further provided with a lens groove and a positioning protrusion, the lens is provided with a positioning groove, the lens is separately arranged in the lens groove, the positioning protrusion is embedded in the positioning groove to form a positioning, when each of the pivot fasteners is assembled on the mounting base, an end of the mounting shaft is inserted into the insertion hole, and when each of the pivot fasteners is in the unfolded position, each of the pivot fasteners is accommodated in the groove.

5. The pair of glasses having interchangeable lenses of claim 4, wherein the positioning protrusion is located at the front frame corresponding to a bridge of a human nose.

6. The pair of glasses having interchangeable lenses of claim 4, wherein an edge of the inner surface of the front frame is provided with a plurality of outwardly facing trenches, the pair of glasses further comprises a rear frame detachably disposed on the inner surface of the front frame, an edge of the rear frame is provided with a plurality of hook portions, and each of the hook portions is correspondingly hooked to each of the trenches.

7. The pair of glasses having interchangeable lenses of claim 4, wherein the front frame is provided with a plurality of ventilation holes at a periphery adjacent to the lens groove.

8. The pair of glasses having interchangeable lenses of claim 1, wherein the mounting base is fixed to both sides of the lens by one of gluing, welding, locking, embedding, or secondary injection.

9. The pair of glasses having interchangeable lenses of claim 1, wherein the wearing piece is a belt body or two temples.
